(19) United States
(12) Patent Application Publication
(10) Pub. No.: US 2009/0155666 A1
(43) Pub. Date: Jun. 18, 2009

(54) Bipolar plate and process for producing a bipolar plate

(75) Inventors: Thomas Kiefer, Ettlingen (DE); Frank Tietz, Julich (DE)

Correspondence Address: Edward J. Timmer, P.O. Box 770, Richland, MI, 49083, US

(73) Assignees: ElringKlinger AG; Forschungszentrum Julich GmbH

(21) Appl. No.: 12/079,517

(22) Filed: Mar. 27, 2008

Related U.S. Application Data
(63) Continuation of application No. PCT/EP07/11020, filed on Dec. 14, 2007.

(51) Int. Cl. H01M 2/00; B05D 5/12

(52) U.S. Cl. 429/34; 427/115

(57) ABSTRACT

In order to provide a bipolar plate for a fuel cell unit, wherein the bipolar plate comprises a support layer of a metallic material and a protective layer, wherein the protective layer comprises an at least binary oxide system with at least two different types of metal cations, the protective layer of which prevents the formation of an oxide layer or changes the properties of the formed oxide layer such that lower mechanical stresses occur in the oxide layer, it is proposed that one type of metal cation of the oxide system of the protective layer is Mn and a further type of metal cation of the oxide system of the protective layer is Cu.

### RELATED APPLICATION

This application is a continuation application of PCT/EP2007/011020 filed Dec. 14, 2007, the entire specification of which is incorporated herein by reference.

### FIELD OF DISCLOSURE

The present invention relates to a bipolar plate for a fuel cell unit, wherein the bipolar plate comprises a support layer of a metallic material and a protective layer, wherein the protective layer comprises an at least binary oxide system with at least two different types of metal cations.

### BACKGROUND

Since a fuel cell unit only has a low single cell voltage of approximately 0.4 volts to approximately 1.2 volts (depending on load), a series connection of a plurality of electrochemical cells in a fuel cell stack is necessary, as a result of which the output voltage is scaled to a range of interest from an applications viewpoint. For this, the individual electrochemical cells are connected by means of so-called bipolar plates (also referred to as interconnectors).

Ferritic, chromium oxide-forming special steels are usually used as material for bipolar plates in high-temperature fuel cells. One reason for this is that the chromium oxide formed on the surface of the bipolar plate has a comparatively high electrical conductivity, whereas aluminum oxide, for example, has an electrically insulating effect.

In the case of a temperature increase chromium oxide or a double layer (duplex layer), which is composed of chromium oxide and chromium-manganese oxide, forms on the surface of the chromium oxide-forming steel. The specific conductivities of these layers lie in the range of approximately 0.01 S/cm to approximately 1 S/cm with an operating temperature of the fuel cell of 800° C. The coefficients of thermal expansion of the chromium oxide layer or the double layer lie in the range of approximately 6.5·10⁻⁶K⁻¹ to approximately 9.1·10⁻⁶K⁻¹. The coefficients of thermal expansion of the components adjoining the bipolar plate (in particular cathode and interconnector steel) amount to approximately 12.5·10⁻⁶K⁻¹.

The subsequent operation of the high-temperature fuel cell (in particular the SOFC (solid oxide fuel cell)) is associated with an increase in thickness of the oxide layer. Because of the relatively low specific conductivity of the oxide layer, the contact resistance increases as the layer thickness increases, and therefore the fuel cell stack loses performance. Moreover, mechanical stresses (which can be time-dependent) are also induced because of the increase in layer thickness of the oxide layer with a non-matched coefficient of thermal expansion. With the ceramic structural parts used, these mechanical stresses can lead to crack formation and thus to a breakdown of the stack.

Under the operating conditions of a fuel cell, volatile chromium compounds are formed from the spontaneously forming chromium oxide. In particular in long-term operation of the fuel cell stack, this “chromium evaporation” results in a poisoning of the cathode, which causes a drastic reduction in the output of the fuel cell stack. The chromium evaporation can be prevented by a suitable coating of the interconnector steel (e.g. with MnOₓ). However, in this case the oxide layer of the interconnector steel also grows in time. Therefore, either the initial state, in which the chromium oxide layer is not yet significantly pronounced and therefore the coefficient of thermal expansion of the steel substrate should be set at approximately 12.5·10⁻⁶K⁻¹, or a subsequent operating state, in which the coefficient of thermal expansion of the oxide layer should be set at approximately 6.5·10⁻⁶K⁻¹ to approximately 9.1·10⁻⁶K⁻¹, must form the basis for the dimensioning of an appropriate coefficient of thermal expansion for the protective layer. Therefore, a compromise is unavoidable.

Moreover, to prevent the chromium evaporation, it has already been proposed to dope specific elements (e.g. Mn, Ni, Co) into the steel of the bipolar plate, which influence growth of the oxide layer and convert the originally formed chromium oxide into a more chemically stable form. While a minimisation of the chromium evaporation can be achieved as a result of such alloy additions, no lasting protection of the cathode is provided.

Moreover, when doping alloy additions into the steel, limits are set with respect to the layer thickness and the composition thereof on the basis of thermodynamic laws of the oxide layer.

The growth of a chromium oxide layer on the interconnector steel is not prevented with the above-mentioned measures, and this leads to an increase in mechanical stresses and to a rise in the contact resistance.

### SUMMARY OF THE INVENTION

The object forming the basis of the present invention is to provide a bipolar plate of the aforementioned type, the protective layer of which prevents the formation of an oxide layer or changes the properties of the formed oxide layer such that lower mechanical stresses occur in the oxide layer.

This object is achieved according to the invention with a bipolar plate with the features of the preamble of claim 1 in that one type of metal cation of the oxide system of the protective layer is Mn and a further type of metal cation of the oxide system of the protective layer is Cu.

It has been found that because of a coating of the interconnector material with an oxide layer, which contains Mn and Cu, the oxide layer of the interconnector material forming during operation of the fuel cell unit can be modified so that desirable work material properties (e.g. an adapted coefficient of thermal expansion, a favourable electrical conductivity and a high chemical stability) can be obtained for the oxide layer formed.

In the ideal case, the formation of an oxide layer between the interconnector material and the protective layer during operation of the fuel cell unit can be completely prevented by the coating.

The modification effect of the protective layer according to the invention on the oxide layer formed during operation of the fuel cell unit can be based on the fact that the enthalpy of formation of the new oxide layer, which contains Mn and/or Cu from the protective layer, lies on a lower energy level than the enthalpy of formation of spontaneously forming oxidation layers of Cr₂O₃ layers or of Cr—Mn spinel layers.

Alternatively, it is also conceivable that the oxide layer formed in the presence of the protective layer is present in a metastable state and the kinetics of conversion into a more thermodynamically stable range with respect to the total service life of the bipolar plate is sufficiently slow. This can be the case in particular if the protective layer reacts with the (still) metallic (“unoxidised”) surface of the material of the support layer more quickly than the normal oxide layer can form on the metallic material of the support layer, and/or if as a result of an increased bonding temperature (which is higher than the operating temperature of the fuel cell unit) a stable modified oxide layer is formed, which at bonding temperature is preferred thermodynamically over a chromium oxide layer and is then present in metastable form in the case of a reduction in the temperature to the operating temperature of the fuel cell unit.

It has proved particularly advantageous for a desirable modification of the oxide layer formed during operation of the fuel cell unit if the oxide system of the protective layer has approximately the nominal composition Mn₂₋ₓCu₁₊ₓO₄, where 0≦x<2.

The oxide system with the approximately nominal composition Mn₂CuO₄ has proved especially favourable. With a protective layer that has such an oxide system, the formation of an oxide layer on the support layer can be completely prevented in favourable circumstances.

It can be advantageous for the modification of the oxide system if the configuration of the oxide system of the protective layer is at last two-phase.

In this case, it can be provided in particular that one phase of the oxide system of the protective layer has approximately the composition Mn_{1.5}Cu_{1.5}O₄ and a further phase of the oxide system of the protective layer has approximately the composition CuO.

If the formation of an oxide layer during operation of the fuel cell unit cannot be completely prevented by the presence of the protective layer, then the bipolar plate has an oxide layer formed between the support layer and the protective layer during operation of the fuel cell unit.

In a preferred configuration of the invention, the chemical composition of the oxide layer is changed by the presence of the protective layer in relation to the chemical composition of an oxide layer formed on the support layer during operation of the fuel cell unit without the presence of the protective layer.

In particular, it can be provided that the oxide layer does not contain Cr spinel.

It can be additionally provided that the oxide layer does not contain Cr—Mn spinel.

The oxide layer formed during operation of the fuel cell unit preferably contains Mn cations and/or Cu cations, which in particular can originate from the protective layer.

The composition of the protective layer of the bipolar plate is preferably selected such that the coefficient of thermal expansion α of the oxide layer formed between the support layer and the protective layer during operation of the fuel cell unit amounts to at least approximately 8·10⁻⁶K⁻¹. Such a coefficient of thermal expansion is adapted particularly well to the thermal expansion behaviour of the other components of the bipolar plate and the fuel cell unit.

Moreover, the composition of the protective layer of the bipolar plate is preferably selected such that the specific electrical conductivity σ of the oxide layer formed between the support layer and the protective layer during operation of the fuel cell unit amounts to at least approximately 0.1 S/cm.

In a preferred configuration of the invention the material of the support layer of the bipolar plate comprises a steel material.

In particular, it can be provided that the material of the support layer comprises a chromium oxide-forming steel material.

Moreover, it has been found that the properties of the oxide layer formed during operation of the fuel cell unit can be positively influenced if the material of the support layer is doped with Si and/or Ti.

The material of the support layer preferably contains at most 1% by weight Si and/or at most 1% by weight Ti.

The bipolar plate according to the invention is particularly suitable for use in a high-temperature fuel cell, in particular an SOFC (solid oxide fuel cell) with an operating temperature of at least 600° C., for example. The present invention additionally relates to a process for producing a bipolar plate for a fuel cell unit.

A further object forming the basis of the invention is to provide such a process, by means of which a bipolar plate is produced, the protective layer of which prevents the formation of an oxide layer on the support layer of the bipolar plate during operation of the fuel cell unit or modifies the properties of such a spontaneously formed oxide layer such that lower mechanical stresses occur in the oxide layer.

This object is achieved according to the invention by a process for producing a bipolar plate for a fuel cell unit, which comprises the following process steps:
applying a layer of a protective layer starting material to a support layer of the bipolar plate, wherein the protective layer starting material comprises Mn and Cu;
increasing the temperature to a sintering temperature;
cooling the support layer and the protective layer formed at the sintering temperature.

In a preferred configuration of the process according to the invention, the protective layer starting material is applied to the support layer using a wet-chemical method.

In this case, the starting material can be sprayed onto the support layer, for example, or also applied to the support layer by means of a dispenser in the screen-printing process.

Further special configurations of the process according to the invention are the subject of claims 21 to 26, the features and advantages of which have already been explained above in association with the special configurations of the bipolar plate according to the invention.

The following advantages are provided because the properties of an oxide layer formed between the support layer and the protective layer during operation of the fuel cell are modified by the process according to the invention and the bipolar plate according to the invention:
The formation of mechanical stresses in long-term operation of the fuel cell unit is prevented. Therefore, no inherent stresses occur, which continuously increase with time in the case of a non-modified chromium oxide layer with non-matched coefficient of thermal expansion and layer thickness that constantly increases during operation of the fuel cell unit and in particular in the case of thermal cycling can lead to crack formation and thus to degradation and breakdown of the fuel cell stack.
In the selection of material for a suitable protective layer no compromise needs to be found as to whether the coefficient of thermal expansion of this layer should be adapted to that of the initial state or to that of the subsequent operating state.
The electrical conductivity of the poorly conducting oxide layer in the non-modified state is improved, which results in an improvement of the performance of the entire fuel cell stack. Aging as a result of an increase in oxide layer thickness can also be excluded.

A material depletion in the oxide layer forming between the support layer and the protective layer, in particular as a result of defects and pores occurring, and also a delamination of the oxide layer can be substantially prevented by provision of the protective layer according to the invention.

Further features and advantages of the invention are the subject of the following description and the diagrammatic representation of exemplary embodiments.

### IN THE DRAWINGS

FIG. 1 shows a schematic section through a bipolar plate with a protective layer, a support layer and an oxide layer formed between the protective layer and the support layer.

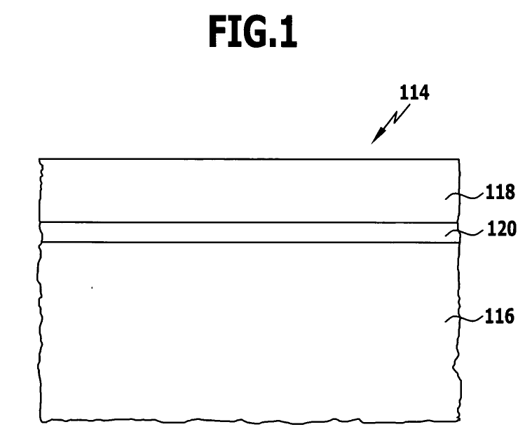

To produce the bipolar plate shown in a cut-out longitudinal section in FIG. 1, the procedure is as follows:

A support layer is provided comprising a ferritic, chromium oxide-forming special steel, e.g. Crofer 22 APU special steel, which has the following composition: 22.2% by weight Cr; 0.46% by weight Mn; 0.06% by weight Ti; 0.07% by weight La; 0.002% by weight C; 0.02% by weight Al; 0.03% by weight Si; 0.004% by weight N; 0.02% by weight Ni; the remainder iron.

In a first exemplary embodiment, in a screen-printing process a paste is applied onto this support layer that has the following composition: 237.43 parts by weight of a ceramic powder; 225.56 parts by weight of terpineol; 11.9 parts by weight of ethyl cellulose.

The ceramic powder for this paste is produced as follows:

Firstly, a quantity of two different metal oxides, e.g. Mn₂O₃ and CuO, are weighed so that the numerical ratio of the respective metal cations (e.g. Mn and Cu) corresponds to the numerical ratio in the desired composition of the protective layer to be produced.

The weighed metal oxide powders are placed in a polyethylene bottle together with ethanol and ZrO₂ grinding balls (with an average diameter of approximately 0.3 mm).

In this case, the weight ratio of powder (metal oxide powder) : ethanol grinding balls preferably amounts to 1:2:3.

Therefore, in particular, 157.88 parts by weight of Mn₂O₃ and 79.55 parts by weight of CuO, i.e. a total of 237.43 parts by weight of metal oxide powder, for example, can be used together with 474.86 parts by weight of ethanol and 712.29 parts by weight of grinding balls.

The ceramic powder, ethanol and grinding balls are mixed together in the polyethylene bottle and ground on a roller bench until a grain size of the powder of d₉₀=1 μm is reached.

A grain size of d₉₀=1 μm means that 90% by weight of the particles of the ceramic powder have a grain size of 1 μm at most.

To prevent agglomeration, a dispersing agent (e.g. the dispersing agent with the designation ET-85 from Dolapix) can be selectively added to the mixture of powder, ethanol and grinding balls before grinding or during grinding.

In this case, the dispersing agent is preferably added in a proportion of 1% by weight to 40% by weight of the ceramic powder.

After the desired grain size of the ceramic powder has been reached, the grinding balls are removed by sieving and the suspension is dried.

The paste for the screen-printing process is then produced using this ceramic powder as follows:

225.56 parts by weight of terpineol and 11.9 parts by weight of ethyl cellulose are mixed together by stirring.

This mixture is then homogenised with 237.43 parts by weight of the ceramic powder produced in the above manner on a 3-roller frame in a plurality of stages and is processed to a paste.

In this case, the viscosity of the paste can range from approximately 100 dPas to approximately 700 dpas.

The paste of protective layer starting material is then applied to the support layer of the bipolar plate by means of a screen-printing assembly known per se to the person skilled in the art with a wet layer thickness of approximately 10 μm to approximately 100 μm, for example.

Alternatively to the above-described screen-printing process a wet spraying process can also be used to apply the ceramic powder to the support layer.

In this case, a suspension is sprayed onto the support layer that has the following composition: 237.43 parts by weight of a ceramic powder; 4.74 parts by weight of a dispersing agent (e.g. the dispersing agent with the designation ET-85 from Dolapix); 23.74 parts by weight of a binding agent (e.g. polyvinyl acetate, PVAC).

The ceramic powder for the suspension is produced as follows:

Firstly, a quantity of two different metal oxides, e.g. Mn₂O₃ and CuO, are weighed so that the numerical ratio of the respective metal cations (e.g. Mn, Cu) corresponds to the numerical ratio in the desired composition of the protective layer to be produced.

The weighed metal oxide powders are placed in a polyethylene bottle together with ethanol and ZrO₂ grinding balls (with an average diameter of approximately 0.3 mm). Therefore, for example, 157.88 parts by weight of Mn₂O₃ and 79.55 parts by weight of CuO, (i.e. together 237.43 parts by weight of ceramic powder) together with 474.86 parts by weight of ethanol and 712.29 parts by weight of grinding balls together with 4.74 parts by weight of the dispersing agent are mixed together in a polyethylene bottle.

The polyethylene bottle is then rotated on a roller bench until the grain size of the ceramic powder amounts to d₉₀=1 μm.

After the desired grain size of the ceramic powder has been reached, the grinding balls are removed from the suspension by sieving. 4.74 parts by weight of dispersing agent (e.g. ET-85 from Dolapix) and 23.74 parts by weight of the binding agent (e.g. polyvinyl acetate) are then added to the suspension, and the suspension is homogenised by shaking—e.g. for approximately 30 minutes.

The weight ratio of the materials used in the production of the suspension ceramic powder:ethanol:grinding balls:dispersing agent:binder preferably amounts to approximately 1:2:3:2×0.02:0.1.

The suspension obtained in this manner is sprayed onto the support layer through a spray nozzle in the wet spraying process.

In this case, the diameter of the nozzle orifice, with which the suspension is atomised, amounts to approximately 0.5 mm.

The spraying pressure, with which the suspension is transported to the nozzle, amounts to 0.3 bar, for example.

The spraying distance of the nozzle from the support layer (substrate) amounts to 15 cm, for example.

The nozzle is moved across the support layer at a speed of 230 mm/s, for example.

The layer of the protective layer starting material is applied to the support layer in one to six coating cycles, i.e. by coating each surface region of the support layer once to six-times.

Instead of the oxides corresponding quantities of metals (e.g. Mn, Cu) and/or calcined powder (e.g. Mn₂CuO₄) can be used both in the screen-printing process and in the wet spraying process.

A mixture of these three possibilities (metal, oxide, calcined powder) is also conceivable.

After the layer of the protective layer starting material has been applied to the metallic support layer, e.g. by the screen-printing process or the wet spraying process, the coated support layer is subjected to a heat treatment.

In this case, the support layer with the protective layer starting material arranged thereon is heated in a sintering oven and brought to a sintering temperature.

The sintering temperature is higher than the operating temperature (e.g. approximately 600° C. to approximately 900° C.) of the fuel cell unit, in which the bipolar plate is to be used.

Since the heat treatment of the support layer can decisively influence the service life of the fuel cell stack configured from the fuel cell units, sintering temperatures higher than approximately 1100° C. to approximately 1200° C. are not appropriate.

Moreover, the holding time at the sintering temperature should not be longer than 10 hours.

For example, the support layer with the applied layer of the protective layer starting material can be subjected to a heat treatment at a sintering temperature of 950° C. with a holding time of 10 hours.

In this case, the support layer with the protective layer starting material can be heated to the sintering temperature at a heating rate of 3 K/min, for example.

The cooling of the support layer with the sintered protective layer formed by the heat treatment arranged thereon can occur through natural cooling with a cooling rate of approximately 10 K/min, for example.

After installation of the bipolar plate formed from the support layer and the protective layer configured thereon into a fuel cell unit, an oxide layer is formed between the support layer and the protective layer at the operating temperature of the fuel cell unit (of approximately 600° C. to approximately 900° C., for example), the chemical composition of said oxide layer being changed by the coating of the steel substrate with the protective layer in relation to the chemical composition of an oxide layer formed without the presence of such a protective layer.

The bipolar plate, given the overall reference 114, obtained after oxidation during operation of the fuel cell unit and comprising the support layer 116, the protective layer 118 with the exemplary nominal composition Mn₂CuO₄ and an oxide layer 120 formed between the support layer 116 and the protective layer 118 with the exemplary nominal composition Cr_{0.7}Mn_{1.3}CuO₄ is shown in a purely schematic view in longitudinal section in FIG. 1.

The oxide layer 120 does not contain Cr spinel or Mn spinel.

The oxide layer 120 does not show any delamination or material depletion as a result of defects or pore formation.

At a temperature of 800° C. the specific electrical conductivity of the oxide layer 120 formed during operation of the fuel cell unit is higher than 40 S/cm, i.e. significantly higher than the specific electrical conductivity of Cr₂O₃ at the same temperature (0.03 S/cm).

The coefficient of thermal expansion a of the oxide layer 120 amounts to approximately 12·10⁻⁶K⁻¹ and is therefore significantly higher than the coefficient of thermal expansion of Cr₂O₃ (6.5·10⁻⁶K⁻¹).

Therefore, the coefficient of thermal expansion a of the oxide layer 120 lies in the range of the coefficient of thermal expansion of the other components of the fuel cell unit (from approximately 12·10⁻⁶K⁻¹ to approximately 13·10⁻⁶K⁻¹).

The reduction in the thermal displacement leads to a reduction in the undesirable mechanical inherent stresses of the oxide layer 120 in relation to an oxide layer, which is formed on the surface of the support layer 116 during operation of the fuel cell unit without the presence of the protective layer 118.

1. Bipolar plate for a fuel cell unit, wherein the bipolar plate comprises a support layer of a metallic material and a protective layer, wherein the protective layer comprises an at least binary oxide system with at least two different types of metal cations, wherein one type of metal cation of the oxide system of the protective layer is Mn and a further type of metal cation of the oxide system of the protective layer is Cu.

2. Bipolar plate according to claim 1, wherein the oxide system of the protective layer has approximately the nominal composition Mn₂₋ₓCu₁₊ₓO₄, where 0≦x<2.

3. Bipolar plate according to claim 2, wherein the oxide system of the protective layer has approximately the nominal composition Mn₂CuO₄.

4. Bipolar plate according to claim 1, wherein the configuration of the oxide system of the protective layer is at last two-phase.

5. Bipolar plate according to claim 4, wherein one phase of the oxide system of the protective layer has approximately the composition Mn_{1.5}Cu_{1.5}O₄ and a further phase of the oxide system of the protective layer has approximately the composition CuO.

6. Bipolar plate according to claim 1, wherein the bipolar plate has an oxide layer formed between the support layer and the protective layer during operation of the fuel cell unit.

7. Bipolar plate according to claim 6, wherein the chemical composition of the oxide layer is changed by the presence of the protective layer in relation to the chemical composition of an oxide layer formed on the support layer during operation of the fuel cell unit without the presence of the protective layer.

8. Bipolar plate according to claim 6, wherein the oxide layer does not contain Cr spinel.

9. Bipolar plate according to claim 6, wherein the oxide layer does not contain Cr—Mn spinel.

10. Bipolar plate according to claim 6, wherein the oxide layer contains Mn cations and/or Cu cations.

11. Bipolar plate according to claim 6, wherein the coefficient of thermal expansion α of the oxide layer amounts to at least approximately 8·10⁻⁶K⁻¹.

12. Bipolar plate according to claim 6, wherein the specific electrical conductivity σ of the oxide layer amounts to at least approximately 0.1 S/cm.

13. Bipolar plate according to claim 1, wherein the material of the support layer comprises a steel material.

14. Bipolar plate according to claim 13, wherein the material of the support layer comprises a chromium oxide-forming steel material.

15. Bipolar plate according to claim 1, wherein the material of the support layer is doped with Si and/or Ti.

16. Bipolar plate according to claim 15, wherein the material of the support layer contains at most 1% by weight Si and/or at most 1% by weight Ti.

17. Process for producing a bipolar plate for a fuel cell unit comprising the following process steps:
applying a layer of a protective layer starting material to a support layer of the bipolar plate, wherein the protective layer starting material comprises Mn and Cu;
increasing the temperature to a sintering temperature;
cooling the support layer and the protective layer formed at the sintering temperature.

18. Process according to claim 17, wherein the protective layer starting material is applied to the support layer using a wet-chemical method.

19. Process according to claim 18, wherein the protective layer starting material is sprayed onto the support layer.

20. Process according to claim 18, wherein the protective layer starting material is applied to the support layer using the screen-printing process.

21. Process according to claim 17, wherein the protective layer starting material has approximately the nominal composition Mn₂₋ₓCu₁₊ₓO₄, where 0≦x<2.

22. Process according to claim 21, wherein the protective layer starting material has approximately the nominal composition Mn₂CuO₄.

23. Process according to claim 17, wherein a support layer is used, the material of which comprises a steel material.

24. Process according to claim 23, wherein a support layer is used, the material of which comprises a chromium oxide-forming steel material.

25. Process according to claim 17, wherein a support layer is used, the material of which is doped with Si and/or Ti.

26. Process according to claim 25, wherein a support layer is used, the material of which contains at most 1% by weight Si and/or at most 1% by weight Ti.
